(19) United States
(12) Patent Application Publication
(10) Pub. No.: US 2020/0024896 A1
(43) Pub. Date: Jan. 23, 2020

(54) TAKE-UP DEVICE FOR CURTAIN

(71) Applicants: Zhenbang Lei, Shenzhen (CN); Xingbang Lei, Shenzhen (CN)

(72) Inventors: Zhenbang Lei, Shenzhen (CN); Xingbang Lei, Shenzhen (CN)

(21) Appl. No.: 16/120,215

(22) Filed: Aug. 31, 2018

(30) Foreign Application Priority Data
Jul. 18, 2018 (CN) 201821141285.0

(51) Int. Cl. E06B 9/322; B65H 75/48; B65H 75/44

(52) U.S. Cl. CPC E06B 9/322; E06B 2009/3225; B65H 75/4439; B65H 75/486

(57) ABSTRACT

A take-up device for a curtain includes a pull-cord, a reel mounted to a top beam of the curtain, an actuating mechanism for actuating the reel to rotate to retract or release the pull-cord, and a braking mechanism for braking the pull-cord. The reel defines a winding groove and an actuating slot. The actuating mechanism is a flat spiral-spring assembly. The flat spiral spring assembly includes a wheel arranged in parallel with the reel and a flat spiral-spring. An end of a reed of the flat spiral-spring is wrapped around the wheel, and an opposite end of the reed is fixed in the actuating slot. The top end of the pull-cord is wound on the winding groove, and an opposite end of the pull-cord extends out of the winding groove, extends through the braking mechanism, and then is fixed to a curtain body of the curtain.

### BACKGROUND OF THE INVENTION

### 1. Field of the Invention

The present invention generally relates to curtain technology, and more specifically, relates to a take-up device for a curtain.

### 2. Description of Related Art

A curtain body of a traditional curtain realizes the opening and closing by pulling a pull-cord. Usually, a cord wheel is provided on an upper beam at a top of the curtain for a top end of the pull-cord being wound around, and an opposite end of the pull-cord extends down and is fixed to the curtain body. When the pull-cord is retracted and released, the curtain body is actuated to open and close. The opening and closing of a curtain body of a current curtain relies on the operator to manually pull an operation-cord so as to actuate the pull-cord to be retracted and released accordingly, which is very laborious to operate, especially when it is necessary to pull the curtain body upward to open the curtain, it must also overcome the gravity of the curtain body itself. For some large curtains, the required force is very large, and when the curtain body moves downward to close the curtain, the curtain body is easy to fall quickly due to its own weight and the safety is insufficient, and the operator can only pull the operation-cord to slowly release the operation-cord so as to control a falling speed of the curtain body, which is still very hard to operate.

### SUMMARY OF THE INVENTION

A technical problem to be solved of the present disclosure is to provide a take-up device for a curtain, which can realize the opening and closing operation of a curtain body of the curtain more labor-saving and safe.

To resolve the above-mentioned technical problems, the present invention provides a take-up device for a curtain. The take-up device includes at least one pull-cord, at least one reel mounted to a top beam of the curtain for a top end of the corresponding pull-cord being wound thereon, at least one actuating mechanism for actuating the corresponding reel to rotate to retract or release the corresponding pull-cord, and at least one braking mechanism for braking the corresponding pull-cord. An external periphery surface of each of the at least one reel defines at least one winding groove and an actuating slot in an axial direction of the reel. Each of the at least one actuating mechanism is a flat spiral-spring assembly. The flat spiral spring assembly includes a wheel arranged in parallel with the corresponding reel and a flat spiral-spring. An end of a reed of the flat spiral-spring is wrapped around the wheel, and an opposite end of the reed of the flat spiral-spring is fixed in the actuating slot of the corresponding reel. The top end of each of the at least one pull-cord is wound on the corresponding winding groove of the corresponding reel, and an opposite end of the pull-cord extends out of the winding groove, extends through the corresponding braking mechanism, and then is fixed to a curtain body of the curtain.

Furthermore, the at least one reel includes two reels, the reels each is connected to at least one pull-cord.

Furthermore, the external periphery surfaces define meshing teeth at opposite ends of the reels to form gears, and the gears of the two reels are respectively meshed with each other.

Furthermore, each of the at least one braking mechanism includes a base, and a pressing plate rotatably mounted to the base through a rotation shaft, the pressing plate forms a pressing portion cooperating with the base to clamp or loosen the corresponding pull-cord, the base forms a plurality of first friction shafts facing the pressing portion, the pressing portion forms a plurality of second friction shafts facing the base and staggered with the corresponding first friction shafts, the pressing plate forms a fixing pole at an end, the pull-cord extending out of the reel extends through the first friction shafts and the second friction shafts, and is fixed to the curtain body after extending about the fixing pole, when the curtain body is moved up and down, the pressing portion is rotated by the corresponding pull-cord between a clamping position and a loose position relative to the base; when the pressing portion is in the clamping position, the second friction shafts actuate the pull-cord to wander between the first friction shafts and the second friction shafts.

Furthermore, the take-up device further includes a mounting box mounted to the top beam, the at least one reel and the at least one actuating mechanism are mounted in the mounting box.

Furthermore, an inner surface of a top wall of the mounting box includes a bottom box that is open toward a bottom of the mounting box, and a cover that covers the opening of the bottom box, an inner surface of a sidewall of the bottom box opposite to the cover and a side of the cover facing the bottom box each forms a positioning pole, the wheel is mounted in the bottom box, and opposite ends of the wheel are respectively fixed by the positioning poles, the opposite end of the reed of the flat spiral-spring extends out of a sidewall of the bottom box adjacent to the reel.

Furthermore, the mounting box is further mounted with a cord guide opposite to each of the at least one winding groove of the reel and located between the cover and an inner surface of a bottom wall of the mounting box, the cord guide defines a cord slot through which the corresponding pull-cord extends.

Furthermore, the reel defines at least two parallel winding grooves, each winding groove is wound with a corresponding pull-cord, and each cord guide defines a cord slot corresponding to each winding groove.

Furthermore, the cord guide defines a through hole, the bottom wall and the cover of the mounting box define shaft holes corresponding to the through hole, a shaft extends through the through hole of the cord guide, and opposite ends of the shaft are accommodated in the corresponding shaft holes of the bottom wall and the cover of the mounting box.

Furthermore, positioning portions extend from an inner surface of the mounting box, for positioning the corresponding reel.

According to the above-mentioned technical solutions, the present disclosure has at least the following advantages. The embodiment of the present disclosure provides the driving power to drive the reel by the elastic deformation of the reed of the flat spiral-spring of the flat spiral-spring assembly, thereby more effortlessly actuating the pull-cord to be retracted. When the pull-cord is released, because the weight of the curtain itself is larger, it is also possible to provide a certain reverse resistance by the flat spiral-spring assembly and the braking mechanism to prevent the curtain body from sliding too fast under the action of gravity, and the safety is better.

### DESCRIPTION OF THE DRAWINGS

FIG. 1 is an exploded, isometric view of a take-up device for a curtain of an embodiment of the present invention.

FIG. 2 is a partially assembled, plan view of the take-up device of FIG. 1 and the curtain.

FIG. 3 is an assembled, cross-sectional view of the take-up device of FIG. 1 and a top beam of the curtain.

FIG. 4 is an exploded, isometric view of a take-up device for a curtain of another embodiment of the present invention.

FIG. 5 is a partially assembled, plan view of the take-up device of FIG. 4 and the curtain.

FIG. 6 is an assembled, cross-sectional view of the take-up device of FIG. 4 and a top beam of the curtain.

### DETAILED DESCRIPTION OF THE INVENTION

The invention will be further described in detail below with reference to the accompanying drawings and specific embodiments. It is to be understood that the following illustrative embodiments and illustrations are merely illustrative of the invention, and are not intended to limit the invention, and the embodiments of the present invention and the features of the embodiments may be combined with each other without conflict.

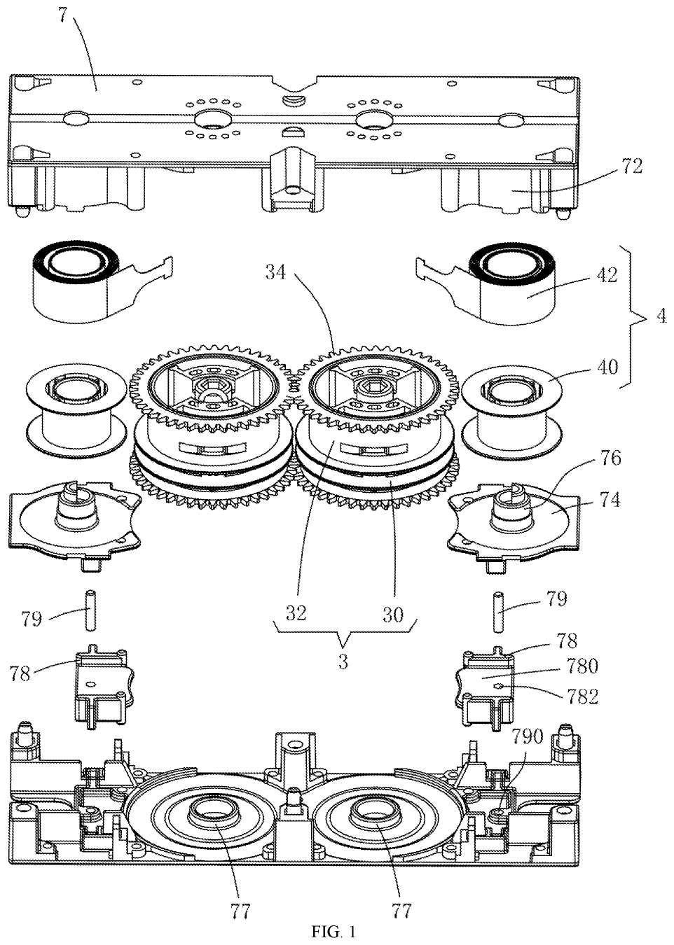

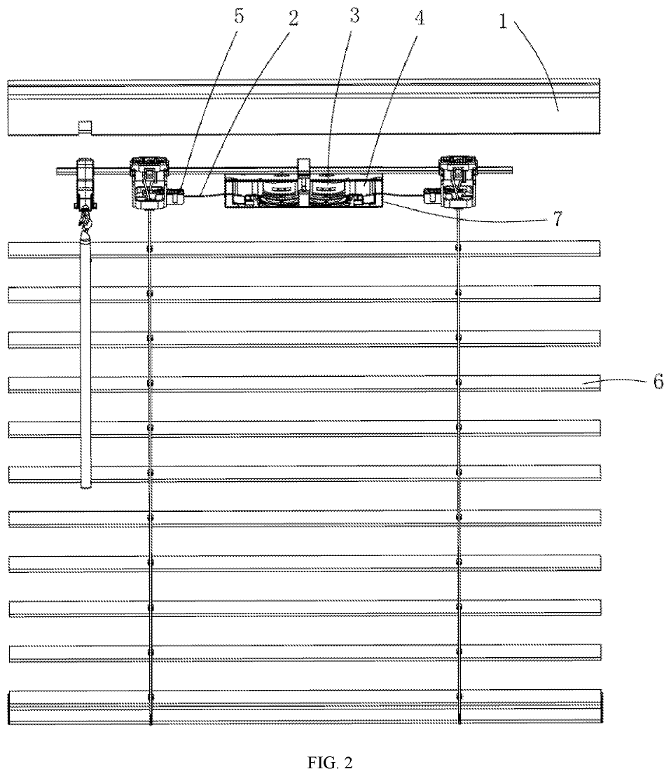

Referring to FIGS. 1-3, a take-up device for a curtain of an embodiment of the present disclosure includes a pull-cord 2, a reel 3 mounted to a top beam 1 of the curtain for winding a top end of a pull-cord 2, an actuating mechanism for actuating the reel 3 to rotate to retract or release the pull-cord 2, and a braking mechanism 5 for braking the pull-cord 2.

An external periphery surface of the reel 3 defines a winding groove 30 and an actuating slot 32 side by side in an axial direction of the reel 3. The actuating mechanism is a flat spiral-spring assembly 4. The flat spiral-spring assembly 4 includes a wheel 40 arranged in parallel with the reel 3, and a flat spiral-spring 42. An end of a reed of the flat spiral-spring 42 is wrapped around the wheel 40, and an opposite end of the reed of the flat spiral-spring 42 is fixed in the actuating slot 32 of the reel 3. The top end of the pull-cord 2 is wound around the winding groove 30 of the reel 3, and an opposite end of the pull-cord 2 extends out of the winding groove 30 and then extends through the braking mechanism 5 to be fixed to a curtain body 6 of the curtain.

In the embodiment, the elastic deformation of the reed of the flat spiral-spring 42 of the flat spiral-spring assembly 4 is used to provide the power to actuate the reel 3 to rotate, which can save effort to pull the pull-cord 2 to retract. When the pull-cord 2 is released, the curtain body 6 itself has a large weight, and the flat spiral-spring assembly 4 and the braking mechanism 5 can also provide a certain reverse resistance to prevent the curtain body 6 from falling too fast under the action of gravity, which is more safely.

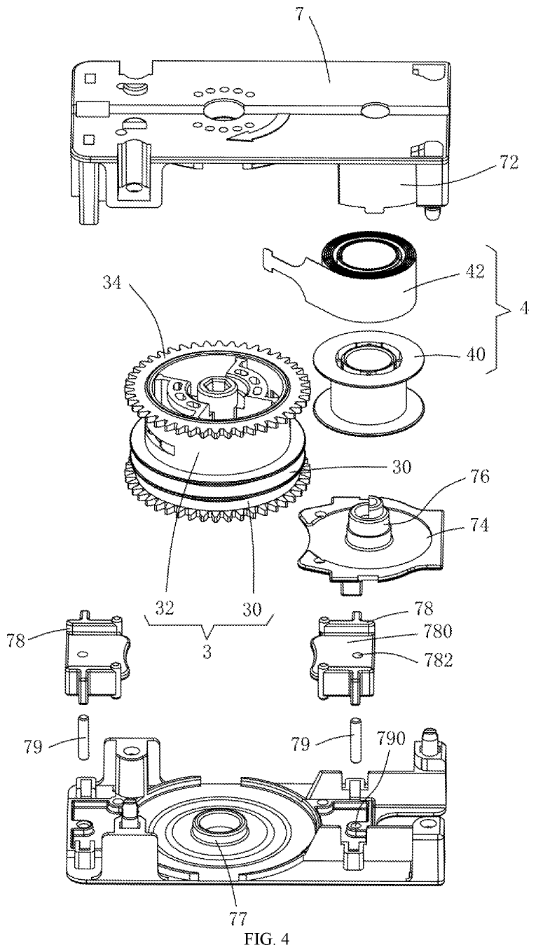

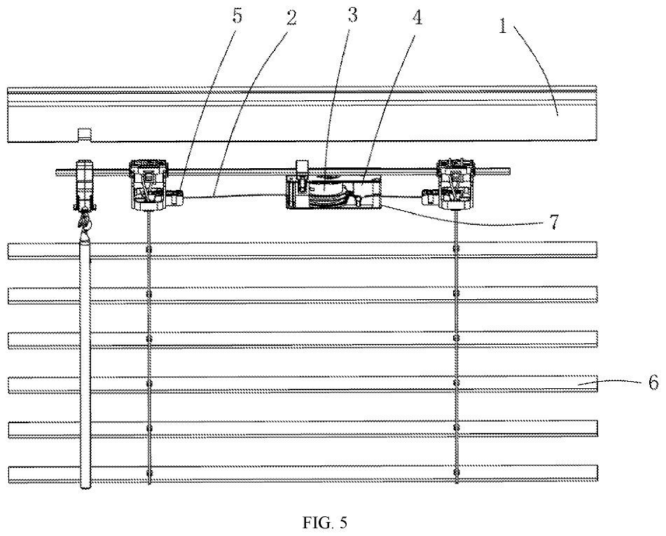

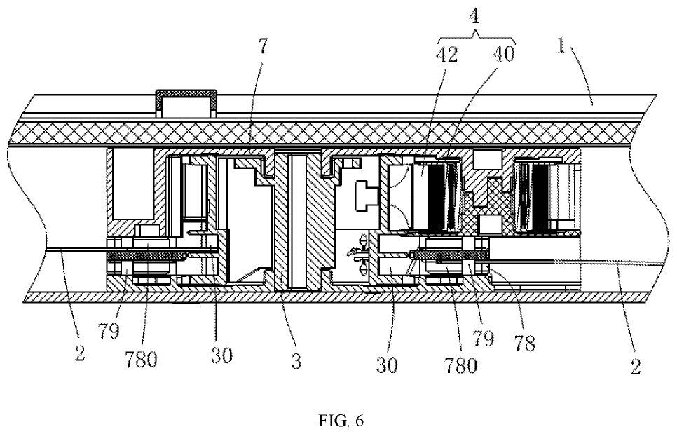

In an alternative embodiment, referring to FIGS. 1-3, a take-up device includes two reels 3 each connected to at least one pull-cord 2. In the embodiment, by providing two reels 3 and each reel 3 correspondingly connecting at least one pull-cord 2, a plurality of pull-cords 2 can be arranged for the larger curtains, thereby pulling the curtain body 6 to move more evenly. While in the embodiment as shown in FIGS. 4-6, a take-up device is provided with only one reel 3, and one pull-cord 2 is connected to each of two sides of the reel 3. Correspondingly, two winding grooves 30 are defined in the reel 3 to respectively wind the corresponding pull-cords 2. Therefore, the pull-cords 2 on both sides are simultaneously actuated by one reel 3 to realize the pull-cord 2 to be retracted or released.

In an alternative embodiment, referring to FIGS. 1-3, the external periphery surfaces at opposite ends of the reels 3 define meshing teeth to form gears 34, and the gears 34 of the two reels 3 are respectively meshed with each other. In the embodiment, by providing gears 34 on the two reels 3 to mesh with each other, when one of the reels 3 is rotated, the other reel 3 is synchronously rotated. Therefore, the synchronous retracting and releasing of the pull-cords 2 arranged on both sides can be better realized, and the balance of the curtain body 6 can be ensured.

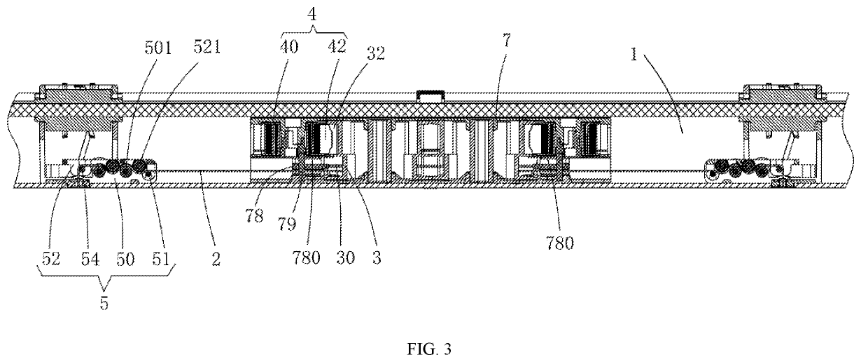

In an alternative embodiment, referring to FIG. 3, the braking mechanism 5 includes a base 50, and a pressing plate 52 rotatably mounted to the base 50 through a rotation shaft 51. The pressing plate 52 forms a pressing portion (not labeled) that cooperates with the base 50 to clamp or loosen the pull-cord 2. A plurality of first friction shafts 501 extends from a side of the base 50 facing the pressing portion. A plurality of second friction shafts 521 extends from a side of the pressing portion facing the base 50. The second friction shafts 521 are respectively staggered with the first friction shafts 501. The pressing plate 52 forms a fixing pole 54 at an end. The pull-cord 2 extends out of the reel 3 and extends between the first friction shafts 501 and the second friction shafts 521, and is connected to the curtain body 6 after extending about the fixing pole 54. When the curtain body 6 moves up and down, the pressing portion is actuated by the pull-cord 2 to rotate between a clamping position and a loose position relative to the base 50. When the pressing portion is in the clamping position, the second friction shafts 521 actuate the pull-cord 2 to wander between the first friction shafts 501 and the second friction shafts 521.

The embodiment of the present disclosure provides the first friction shafts 501 on the base 50 and the second friction shafts 521 on the pressing plate 52. Through the cooperation of the first friction shafts 501 and the second friction shafts 521, the frictional resistance to the pull-cord 2 can be effectively increased. By changing the number and positional relationship of the first friction shafts 501 and the second friction shafts 521, it is possible to control the amount of friction between the pull-cord 2 and the first and second friction shafts 501 and the second friction shafts 521. By reasonably designing the braking friction resistance of the braking mechanism 5 and the reverse elastic resistance of the flat spiral-spring 42, it can be reasonably matched with the self-weight of the curtain body 6, and the curtain body 6 can be easily adjusted at any height to facilitate the lifting and lowering operation of the curtain body 6.

In an alternative embodiment, the take-up device further includes a mounting box 7 set on the top beam 1. The reel 3 and the actuating mechanism are mounted in the mounting box 7. The mounting box 7 defines a cord hole 70 or a cord guide slot for the pull-cord 2 extending out of the mounting box 7. By arranging the mounting box 7 to accommodate the reel 3 and the actuating mechanism, it is possible to avoid foreign objects jamming and affect the normal operation of the reel 3 and the actuating mechanism, thereby improving reliability and safety of the take-up device.

In an alternative embodiment, an inner surface of a top wall of the mounting box 7 forms a bottom box 72 that is open toward a bottom of the mounting box 7, and a cover 74 that covers the opening of the bottom box 72. The bottom box 72 defines a through hole (not shown) in a sidewall of the bottom box 72 adjacent to the reel 3. An inner surface of a sidewall of the bottom box 72 opposite to the cover 74 and a side of the cover 74 facing the bottom box 72 each forms a positioning pole 76. The wheel 40 is mounted in the bottom box 72, and opposite ends of the wheel 40 are respectively fixed by the positioning poles 76. The opposite end of the reed of the flat spiral-spring 42 extends out of the bottom box 72 through the through hole. In the embodiment, the flat spiral-spring assembly 4 is accommodated by further providing a bottom box 72 in the mounting box 7, which facilitates installation and further improves the protection of the flat spiral-spring assembly 4 to ensure the normal operation of the flat spiral-spring assembly 4.

In an alternative embodiment, a cord guide 78 opposite to the winding groove 30 of the reel 3 is fixed in the mounting box 7, between the cover 74 and an inner surface of a bottom wall of the mounting box 7. The cord guide 78 defines a cord slot 780 for the pull-cord 2 extending through. By further setting the cord guide 78 in the mounting box 7, the pull-cord 2 can be effectively guided to prevent the pull-cord 2 from being accidentally wound onto other objects or components.

In an alternative embodiment, the reel 3 defines at least two parallel winding grooves 30, and each winding groove 30 is wound with one pull-cord 2. The cord guide 78 defines one cord slot 780 corresponding to each winding groove 30. In the embodiment, at least two cord grooves 30 are defined in each reel 3, so that at least two pull-cords 2 can be wound around each reel 3, which is especially suitable for large curtains, and multiple pull-cords 2 can be uniformly arranged in the curtain body 6 to ensure the balance and stability of the curtain body 6 when the curtain body 6 is lifted and lowered.

In an alternative embodiment, the cord guide 78 defines a through hole 782 perpendicularly communicating with the cord slot 780. The bottom wall and the cover 74 of the mounting box 7 define shaft holes 790 corresponding to the through hole 782. A shaft 79 extends through the through hole 782 of the cord guide 78, and opposite ends of the shaft 79 are accommodated in the corresponding shaft holes 790 of the bottom wall and the cover 74 of the mounting box 7. In the embodiment, the shaft 79 is extended through the cord guide 78 and fixed to the bottom wall and the cover 74 of the mounting box 7, so that the pull-cord 2 in the cord groove 780 extends about the shaft 79 and the necessary guiding limit to the pull-cord 2 is performed by the shaft 79. When the reel 3 is rotated, the end of the pull-cord extending out of the reel 3 is always in a relatively constant position through the limit of the shaft 79, so that the pull-cord 2 can better cooperate with the braking mechanism 5.

In an alternative embodiment, positioning portions 77 extend from an inner surface of the mounting box 7, for positioning the reel 3. In the embodiment, by providing the positioning portions 77 in the mounting box 7, it is convenient to install the reel 3, and it can effectively ensure that the reel 3 does not shift when the reel 3 is rotated.

While the embodiments of the present disclosure have been shown and described, it is understood by those skilled in the art that various changes, modifications, replacement, and variants can be made in the embodiments without departing from the principles and spirit of the present disclosure. The scope of the present disclosure is defined by the appended claims and their equivalents.

What is claimed is:

1. A take-up device for a curtain, comprising:
at least one pull-cord;
at least one reel mounted to a top beam of the curtain, for a top end of the corresponding pull-cord being wound thereon;
at least one actuating mechanism for actuating the corresponding reel to rotate to retract or release the corresponding pull-cord; and
at least one braking mechanism for braking the corresponding pull-cord;
wherein an external periphery surface of each of the at least one reel defines at least one winding groove and an actuating slot side by side in an axial direction of the reel, each of the at least one actuating mechanism is a flat spiral-spring assembly, the flat spiral spring assembly comprises a wheel arranged in parallel with the corresponding reel and a flat spiral-spring, an end of a reed of the flat spiral-spring is wrapped around the wheel, and an opposite end of the reed of the flat spiral-spring is fixed in the actuating slot of the corresponding reel, the top end of each of the at least one pull-cord is wound on the corresponding winding groove of the corresponding reel, and an opposite end of the pull-cord extends out of the winding groove, extends through the corresponding braking mechanism, and then is fixed to a curtain body of the curtain.

2. The take-up device for a curtain of claim 1, wherein the at least one reel comprises two reels, the reels each is connected to at least one pull-cord.

3. The take-up device for a curtain of claim 2, wherein the external periphery surfaces define meshing teeth at opposite ends of the reels to form gears, and the gears of the two reels are respectively meshed with each other.

4. The take-up device for a curtain of claim 1, wherein each of the at least one braking mechanism comprises a base, and a pressing plate rotatably mounted to the base through a rotation shaft, the pressing plate forms a pressing portion cooperating with the base to clamp or loosen the corresponding pull-cord, the base forms a plurality of first friction shafts facing the pressing portion, the pressing portion forms a plurality of second friction shafts facing the base and staggered with the corresponding first friction shafts, the pressing plate forms a fixing pole at an end, the pull-cord extending out of the reel extends through the first friction shafts and the second friction shafts, and is fixed to the curtain body after extending about the fixing pole, when the curtain body is moved up and down, the pressing portion is rotated by the corresponding pull-cord between a clamping position and a loose position relative to the base; when the pressing portion is in the clamping position, the second friction shafts actuate the pull-cord to wander between the first friction shafts and the second friction shafts.

5. The take-up device for a curtain of claim 1, further comprising a mounting box mounted to the top beam, wherein the at least one reel and the at least one actuating mechanism are mounted in the mounting box.

6. The take-up device for a curtain of claim 5, wherein an inner surface of a top wall of the mounting box comprises a bottom box that is open toward a bottom of the mounting box, and a cover that covers the opening of the bottom box, an inner surface of a sidewall of the bottom box opposite to the cover and a side of the cover facing the bottom box each forms a positioning pole, the wheel is mounted in the bottom box, and opposite ends of the wheel are respectively fixed by the positioning poles, the opposite end of the reed of the flat spiral-spring extends out of a sidewall of the bottom box adjacent to the reel.

7. The take-up device for a curtain of claim 6, wherein the mounting box is further mounted with a cord guide opposite to each of the at least one winding groove of the reel and located between the cover and an inner surface of a bottom wall of the mounting box, the cord guide defines a cord slot through which the corresponding pull-cord extends.

8. The take-up device for a curtain of claim 7, wherein the reel defines at least two parallel winding grooves, each winding groove is wound with a corresponding pull-cord, and each cord guide defines a cord slot corresponding to each winding groove.

9. The take-up device for a curtain of claim 7, wherein the cord guide defines a through hole, the bottom wall and the cover of the mounting box define shaft holes corresponding to the through hole, a shaft extends through the through hole of the cord guide, and opposite ends of the shaft are accommodated in the corresponding shaft holes of the bottom wall and the cover of the mounting box.

10. The take-up device for a curtain of claim 5, wherein positioning portions extend from an inner surface of the mounting box, for positioning the corresponding reel.
